(19) United States
(12) Patent Application Publication
(10) Pub. No.: US 2024/0094527 A1
(43) Pub. Date: Mar. 21, 2024

(54) DEFOG LENS FOR VEHICLES

(71) Applicant: Calin Technology Co., Ltd., Taichung City (TW)

(72) Inventors: CHIH-YUNG HSIAO, Taichung City (TW); MENG-CHIEN TSAI, Taichung City (TW); CYUAN-CONG LI, Taichung City (TW); HONG-YEN LIN, Taichung City (TW)

(73) Assignee: Calin Technology Co., Ltd., Taichung City (TW)

(21) Appl. No.: 18/104,635

(22) Filed: Feb. 1, 2023

(30) Foreign Application Priority Data
Sep. 20, 2022 (TW) 111135533

(51) Int. Cl. G02B 27/00; G02B 7/00; H04N 23/52; H04N 23/55

(52) U.S. Cl. CPC G02B 27/0006; G02B 7/008; H04N 23/52; H04N 23/55

(57) ABSTRACT

A defog lens for vehicles includes a lens barrel, a lens, and a hydrophilic layer. The lens barrel has an opening toward an object side. The lens is disposed in the lens barrel and is located at the opening. The hydrophilic layer covers a surface of the lens and includes silicone compounds. Water droplets condensed on the lens could form a sheet film sticking to the surface of the lens and hard to form spherical water droplets, thereby improving the problem that the field of view of the conventional lens is blocked by spherical water droplets, effectively improving the clarity of the image captured by the defog lens, and therefore the defog lens could be applied to various environments.

### BACKGROUND OF THE INVENTION

### Technical Field

The present invention generally relates to an image-capturing device, and more particularly to a defog lens for vehicles.

### Description of Related Art

Conventional camera lenses have been widely used in fields such as vehicle camera modules, access control monitoring systems, and field monitoring systems. However, camera lenses used in environments with high ambient humidity are prone to fogging problems. For example, when the temperature outside a lens of the camera lens (i.e., an ambient temperature) is lower than the temperature inside the lens of the camera lens, the water vapor in the air may condense into small water droplets on the lens of the camera lens because of a large temperature difference between the ambient temperature and the temperature inside the lens, causing the field of view of the lens to be obscured by fog, thus the camera lens cannot capture a clear image through the lens, resulting in the camera lens not being able to function effectively.

Additionally, with advantages in vehicle technology in recent years, vehicle camera modules are also widely used in devices such as automatic driving monitoring devices, driving recorders, and reversing camera devices. In this way, when the fogging problem mentioned above occurs in the lens of the vehicle camera module, it may lead to misjudgment of the environment or road conditions by the driver or the automatic driving system and cause serious harm to the driving safety of the user. Therefore, how to provide a camera lens that could improve the fogging phenomenon of the lens has become a major issue in the industry.

### BRIEF SUMMARY OF THE INVENTION

In view of the reasons mentioned above, the primary objective of the present invention is to provide a defog lens for vehicles, which could improve a problem of fogging on the lens of a camera lens.

The present invention provides a defog lens for vehicles, adapted to capture images, including a lens barrel, a lens, and a hydrophilic layer, wherein the lens barrel has an opening toward an object side of the defog lens. The lens is disposed in the lens barrel and is located at the opening. The hydrophilic layer covers a surface of the lens and includes silicone compounds.

In an embodiment, a thickness of the hydrophilic layer ranges between 10 nm and 50 nm.

In an embodiment, the lens is made of glass.

In an embodiment, the hydrophilic layer is located on an image-side surface of the lens.

In an embodiment, the hydrophilic layer is formed on the surface of the lens by evaporation.

In an embodiment, a heat-resistant temperature of the hydrophilic layer is greater than 100 degrees.

In an embodiment, a contact angle between a droplet and the hydrophilic layer is smaller than 10 degrees.

In an embodiment, a viscosity of the hydrophilic layer ranges between 2 cP and 5 cP.

In an embodiment, a pH value of the hydrophilic layer ranges between 4 and 8.5.

With the aforementioned design, by disposing the hydrophilic layer on the surface of the lens, water droplets condensed on the lens could form a sheet film sticking to the surface of the lens and hard to form spherical water droplets, thereby improving the problem that a field of view of the conventional lens is blocked by spherical water droplets, effectively improving the clarity of the image captured by the defog lens, and therefore the defog lens could be applied to various environments.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view of the defog lens for vehicles according to an embodiment of the present invention.

### DETAILED DESCRIPTION OF THE INVENTION

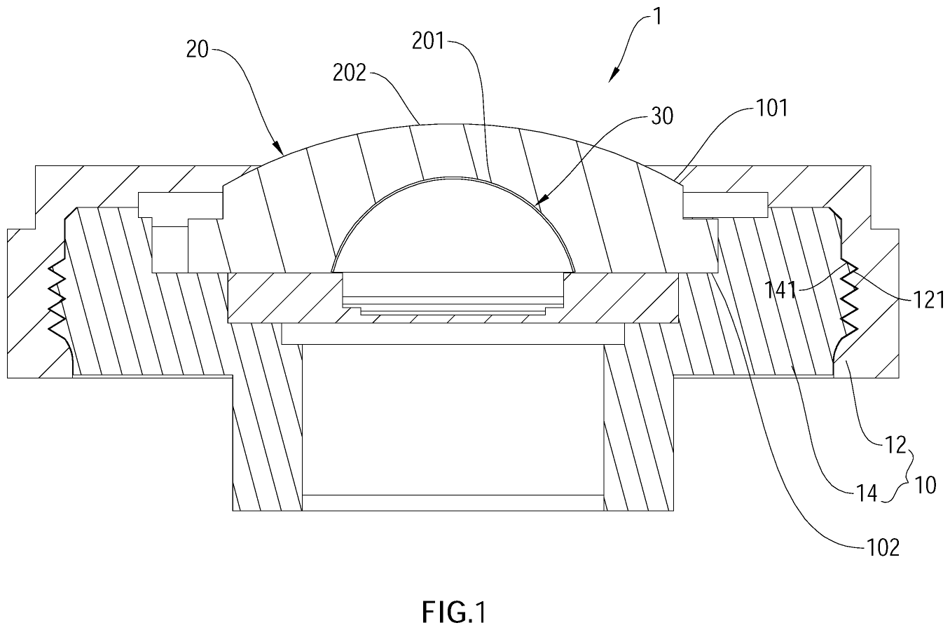

A defog lens 1 for vehicles according to an embodiment of the present invention is illustrated in FIG. 1, which is applied to a vehicle camera for capturing images and includes a lens barrel 10, a lens 20, and a hydrophilic layer 30.

The lens barrel 10 has an opening 101 toward an object side of the defog lens 1. The lens 20 is disposed in the lens barrel 10 and is located at the opening 101 (i.e., the lens 20 is disposed in the lens barrel 10 and is located closest to an outside), wherein the lens 20 could be a convex lens, a concave lens, a filter, a spherical lens, an aspheric lens, a wide-angle lens, or a combination of the foregoing. The lens barrel 10 includes a first lens barrel 12 and a second lens barrel 14, wherein the first lens barrel 12 has the opening 101, and the second lens barrel 14 has an abutting surface 102. An inner wall of the first lens barrel 12 has an internal threaded section 121, and an outer wall of an end of the second lens barrel 14 has an external threaded section 141 matching with the internal threaded section 121, wherein the end of the second lens barrel 14 is disposed in the first lens barrel 12 by screwing the external threaded section 141 with the internal threaded section 121 of the first lens barrel 12. The lens 20 is disposed between the opening 101 of the first lens barrel 12 and the abutting surface 102 of the second lens barrel 14.

The hydrophilic layer 30 covers a surface of the lens 20 and includes silicone compounds, wherein with the hydrophilic layer 30, water droplets condensed on the lens 20 could form a sheet film sticking to the surface of the lens 20 and hard to form spherical water droplets, thereby improving the problem that a field of view of the conventional lens is blocked by spherical water droplets, effectively improving the clarity of the image captured by the defog lens 1, and therefore the defog lens 1 could be applied to various environments.

In the current embodiment, the lens 20 is made of glass, the hydrophilic layer 30 is formed on the surface of the lens 20 by evaporation, and the hydrophilic layer 30 is located on an image-side surface 201 of the lens 20. In this way, when a temperature difference between a temperature inside the lens barrel 10 and an ambient temperature (i.e., a temperature outside the lens barrel 10) is larger, the water vapor in the lens barrel 10 could be prevented from condensing on the image-side surface 201 of the lens 20 that form spherical water droplets, which may affect the clarity of the image captured by the defog lens 1. In practice, the hydrophilic layer 30 could be disposed on both an object-side surface 202 and the image-side surface 201 of the lens 20. In addition, a contact angle between a droplet and the hydrophilic layer is smaller than 10 degrees; a thickness of the hydrophilic layer 30 ranges between 10 nm and 50 nm; a heat-resistant temperature of the hydrophilic layer 30 is greater than 100 degrees; a viscosity of the hydrophilic layer 30 ranges between 2 cP and 5 cP; a pH value of the hydrophilic layer 30 ranges between 4 and 8.5.

With the aforementioned design, by disposing the hydrophilic layer 30 on the surface of the lens 20, water droplets condensed on the lens 20 could form a sheet film sticking to the surface of the lens 20 and hard to form spherical water droplets, thereby effectively improving the clarity of the image captured by the defog lens 1, improving the driving safety of the user, and allowing the defog lens 1 to be applied to various environments.

It must be pointed out that the embodiments described above are only some preferred embodiments of the present invention. All equivalent structures which employ the concepts disclosed in this specification and the appended claims should fall within the scope of the present invention.

What is claimed is:

1. A defog lens for vehicles, adapted to capture images, comprising:
a lens barrel having an opening toward an object side of the defog lens;
a lens disposed in the lens barrel and located at the opening; and
a hydrophilic layer covering a surface of the lens and comprising silicone compounds.

2. The defog lens as claimed in claim 1, wherein a thickness of the hydrophilic layer ranges between 10 nm and 50 nm.

3. The defog lens as claimed in claim 1, wherein the lens is made of glass.

4. The defog lens as claimed in claim 1, wherein the hydrophilic layer is located on an image-side surface of the lens.

5. The defog lens as claimed in claim 1, wherein the hydrophilic layer is formed on the surface of the lens by evaporation.

6. The defog lens as claimed in claim 1, wherein a heat-resistant temperature of the hydrophilic layer is greater than 100 degrees.

7. The defog lens as claimed in claim 1, wherein a contact angle between a droplet and the hydrophilic layer is smaller than 10 degrees.

8. The defog lens as claimed in claim 1, wherein a viscosity of the hydrophilic layer ranges between 2 cP and 5 cP.

9. The defog lens as claimed in claim 1, wherein a pH value of the hydrophilic layer ranges between 4 and 8.5.
